(19) United States
(12) Patent Application Publication
(10) Pub. No.: US 2018/0207726 A1
(43) Pub. Date: Jul. 26, 2018

(54) STRUCTURAL COMPONENT, METHOD FOR PRODUCING A STRUCTURAL COMPONENT AND METHOD FOR DESIGNING A STRUCTURAL COMPONENT

(71) Applicant: Airbus Operations GmbH, Hamburg (DE)

(72) Inventors: Volker Robrecht, Hamburg (DE); Thomas Holder, Hamburg (DE)

(21) Appl. No.: 15/865,888

(22) Filed: Jan. 9, 2018

(30) Foreign Application Priority Data
Jan. 10, 2017 (DE) 10 2017 200 299.9

(51) Int. Cl. B22F 5/10; B29C 64/153; B22F 3/105; B33Y 10/00; B33Y 80/00

(52) U.S. Cl. CPC B22F 5/10; B29C 64/153; B64C 1/12; B33Y 10/00; B33Y 80/00; B22F 3/1055

(57) ABSTRACT

A structural component, in particular for an aircraft, has a grid structure which is constructed from rod elements, wherein the rod elements form basic units which are repeated within the grid structure and each have the same polyhedral outer shape. A first number of reinforcing elements are provided in a first region of the grid structure, and a second number of reinforcing elements are provided in a second region of the grid structure, wherein the second number of reinforcing elements is smaller than the first number of reinforcing elements.

### CROSS-REFERENCE TO RELATED APPLICATION

This application claims priority to German Patent Application DE 10 2017 200 299.9 filed Jan. 10, 2017, the entire disclosure of which is incorporated by reference herein.

### TECHNICAL FIELD

The present disclosure relates to a structural component, in particular for an aircraft, to a method for producing a structural component, and to a method for designing a structural component.

### BACKGROUND

Structural components having what is known as a sandwich construction usually comprise at least one outer cover layer that extends in a planar manner and an adjoining core layer. The core layer is mostly designed as a honeycomb structure made of a material of low density. The cover layer is usually designed as a thin, mechanically resistive plate. This produces a relatively high mechanical strength or rigidity at a low component weight, as a result of which structural components in a sandwich construction are used in a number of different ways, in particular also in aircraft or spacecraft construction.

WO 2015/105859 A1 describes a core layer for a structural component, which core layer is produced from a plurality of open or closed unit cells by a 3D printing method. WO 2015/106021 A1 describes a method for producing a core layer of this kind, in which each individual cell is dimensioned according to the expected mechanical load thereof and is designed having an increased or reduced wall thickness, accordingly.

### SUMMARY

It is an idea of the present disclosure to provide a design for structural components which makes it possible to produce structural components in a simple and efficient manner and such that they have high mechanical rigidity at a low weight.

According to a first aspect of the disclosure herein, a structural component is provided which has a grid structure which is constructed from a plurality of rod elements in a thickness direction. The rod elements form, within the grid structure, repeating basic units which each have the same polyhedral outer shape. In this case, a first number of reinforcing elements are provided in a first region of the grid structure, which region is formed in the thickness direction, and a second number of reinforcing elements are provided in a second region which adjoins the first region in the thickness direction, the second number of reinforcing elements being smaller than the first number of reinforcing elements.

According to the disclosure herein, the structural component therefore comprises a plurality of rod elements which are assembled to form a grid structure. The grid structure is designed in particular so as to extend in a thickness direction. In this case, certain spatial structures delimited by a plurality of rods are repeated within the grid structure, in particular in the thickness direction and optionally also in a longitudinal direction which extends transversely to the thickness direction, or in general along an axis in three-dimensional space. The basic units which are repeated in the thickness direction therefore form the cross-sectional shape of the structural component. The basic units which are optionally repeated in the longitudinal direction define a longitudinal extension of the structural component. The spatial structures or basic units have a polyhedral shape. In particular, the edges of a particular polyhedron are formed by the rod elements. Therefore, in each case, two adjacent basic units share the rod elements which define a face of the polyhedron. Therefore, the basic units form open cells of a spatial grid structure, within which certain basic units are repeated in a spatial direction. With regard to the outer shape of the basic units or basic cells, the grid structure is therefore constructed as a regular grid, which reduces the production costs and as a result of which a simple construction for the structural component is produced. The open-cell grid structure constructed from rod elements is also advantageous in that its weight is low, but its mechanical rigidity is high.

According to the disclosure herein, reinforcing elements are also provided within the grid structure. In particular, separate regions that are adjacent to one another in the thickness direction are provided within the grid structure, in each of which regions a certain number of reinforcing elements are provided. In this case, a larger number of reinforcing elements are provided in a first region than in a second region. The reinforcing elements each couple two rod elements together and thus reduce the force acting on an individual rod element when a force is being applied to the grid structure. This gives the grid structure a lattice construction. Providing reinforcement in regions, i.e. reinforcement over regions which each comprise a plurality of basic units having the same number of reinforcing elements, is advantageous in that there are basic units of an identical construction within the relevant region in each case. In particular, this reduces the manufacturing costs by comparison with providing individually adapted reinforcement for individual basic units. Nevertheless, this also gives the structural component high mechanical rigidity. For example, a plurality of basic units which have the same first number of reinforcing elements can be formed one after the other in the longitudinal direction so as to be one behind the other. These basic units form a first region. An additional region can adjoin the first region in the thickness direction, in which additional region a plurality of basic units which have the same second number of reinforcing elements can be formed one after the other in the longitudinal direction so as to be one behind the other.

In particular, the basic units can have the outer shape of a convex polyhedron. A polyhedron is referred to as being “convex” if, for every two points on the polyhedron, the connecting line between these points is located completely inside the polyhedron.

The structural component according to the disclosure herein can in particular be used as a structural component for an aircraft, for example as a component for forming a fuselage structure, as a support component or the like.

According to one embodiment, the first region of the grid structure can be an “outer” region in relation to the thickness direction. In this case, the first region therefore forms a surface or an outer contour of the structural component. In particular, the first region can completely surround the second region. Alternatively, a third region which is located relative to the first region in the thickness direction can be provided, the second region extending between the first and the third regions.

According to another embodiment, the reinforcing elements extend in the interior space of the relevant basic unit or in the faces of the relevant basic unit. The rod elements form the edges of a polyhedron and therefore define the faces thereof. The faces define the interior space of a particular basic unit. Arranging the reinforcing elements in the faces or in the interior space of a particular basic unit produces mechanically favourable reinforcement.

According to another embodiment, the reinforcing elements can be formed in particular by rods, i.e. as elements of which the cross-sectional diameter is negligible compared with the length thereof. Rods have high mechanical loading capacity relative to their weight. Therefore, the rigidity of the structural component is significantly increased by relatively little additional weight.

According to another development, at least two reinforcing elements in each case can intersect one another in a node point in which the reinforcing elements are interconnected. Therefore, the reinforcing elements are also fastened to one another. This reduces the size of an area delimited by the respective reinforcing elements and one or more rod elements, as a result of which the mechanical load of the individual elements is reduced.

According to another embodiment, the reinforcing elements extend between the rod elements, in particular between vertices of the polyhedron. Therefore, the reinforcing elements extend in particular diagonally across a face of the polyhedron or diagonally through the interior space thereof. This results in an efficient load distribution within the grid structure. Furthermore, this makes it possible for a plurality of identically constructed reinforcing elements to be attached at regularly repeating points on the grid structure. As a result, in the case of a simple constructive design, the mechanical strength of the structural component is increased.

According to another embodiment, the reinforcing elements have a length that is at least 1.41 times the length of the rod elements. The reinforcing elements are thus longer than the rod elements. In the upper range of the factor, the structural component is reinforced in a particularly efficient manner.

According to another embodiment of the structural component, two to five different regions having different numbers of reinforcing elements can be provided within the grid structure. Therefore, more than two adjacent regions can be provided within the grid structure, in each of which a different number of reinforcing elements, in particular for each basic unit, are provided. This makes it possible to relatively precisely adapt the mechanical properties of a particular region to the mechanical load to be expected. At the same time, limiting the number of regions to five is advantageous in that a load-optimised grid structure is produced, while the design is kept constructively simple.

According to a development, the outer shape of the basic units can be a cuboid, a hexahedron, an octahedron, a truncated octahedron, a tetrahedron, a double tetrahedron, a polygonal prism, a dodecahedron, an icosahedron or an icosidodecahedron.

According to another embodiment, the edge length of each basic unit can be in particular in a range of between 2 mm and 15 mm. “Edge length” can be understood in particular to mean the length of a rod element which forms the edge of a particular polyhedron. In the specified range, the grid structure can be produced particularly efficiently by a 3D printing method.

The edge length of each basic unit can in particular be in a range of between 5 mm and 10 mm. In this range, the grid structure has a particularly high mechanical rigidity, with a relatively low amount of material being required for forming the rod elements, and thus at a low weight.

According to another embodiment of the structural component, the rod elements and the reinforcing elements can be made of a plastics material or of a metal material. In particular, a polyamide or an elastomer, such as thermoplastic polyurethane, can be used as the plastics material. In particular, titanium, titanium alloys, aluminium, aluminium alloys or the like can be used as the metal material.

According to another embodiment, gaps for receiving functional components can be formed within the grid structure. In this case, the rod elements are arranged such that there are continuous hollow spaces within the grid structure. In particular, these hollow spaces or gaps can be formed as basic cells that do not have connecting elements extending therein. Gaps are advantageous in that they can be used as channels or receiving spaces for functional components, such as cables, lines or the like.

According to another aspect of the disclosure herein, a method for producing a structural component is provided. The method is suitable in particular for producing a structural component according to one of the embodiments described above. The features and advantages described in respect of the structural component thus apply similarly to the method.

According to the disclosure herein, a grid structure is constructed by a 3D printing method in a thickness direction from a plurality of rod elements such that the rod elements form basic units which are repeated within the grid structure and each have the same polyhedral outer shape. Furthermore, the grid structure is constructed such that, in the thickness direction, a first region of the grid structure is formed having a first number of reinforcing elements and a second region which adjoins the first region in the thickness direction is formed having a second number of reinforcing elements, the second number of reinforcing elements being smaller than the first number of reinforcing elements.

Therefore, in the method, the individual rod elements and reinforcing elements are built up in layers by 3D printing so as to form the grid structure, in particular such that they are continuous or in one piece. Owing to the basic cells that are regularly repeated within the grid structure and within the first or second region, the grid structure can be constructed very rapidly and using inexpensive devices. In particular, the amount of data required to control a 3D printing device by which the method is carried out is relatively low by comparison with methods in which each individual cell of a grid structure is dimensioned individually according to the expected mechanical load.

In generative or additive manufacturing methods, also generally known as “3D printing methods”, starting from a digitalized geometric model of an object, one or more starting materials are sequentially built up one on top of the other in layers and cured.

3D printing methods are advantageous in particular since they make it possible to produce three-dimensional components in primary forming methods without the need for special manufacturing tools adapted to the outer shape of the components. This allows for highly efficient, material-saving and time-saving production processes for components. 3D printing methods are particularly advantageous in the aerospace industry, since a large number of different components are used here which are adapted to specific uses and can be produced in 3D printing methods of this kind at low costs, with low production lead times and low complexity in the manufacturing plants required for production.

According to one embodiment of the method, the 3D printing method can be an SLS method or an SLM method. “SLS” is the abbreviation for “selective laser sintering”. “SLM” is the abbreviation for “selective laser melting”.

In the SLS method and in the SLM method, a component is built up in layers from a modelling material, for example a plastics material (SLS method) or a metal (SLM method), by the modelling material being applied in powder form to an underlayer and being liquefied in a targeted manner by local laser irradiation, whereby, after cooling, a solid, continuous component is produced.

According to another aspect of the disclosure herein, a method for designing a structural component is provided. In a first step, an anticipated loading pattern within the structural component is determined. Furthermore, at least one first region of the structural component that is subject to a high mechanical load and one second region of the structural component that is subject to a low mechanical load are identified. Then, a grid structure is constructed that forms the structural component and comprises a plurality of rod elements, the rod elements forming basic units that are repeated within the grid structure and each have the same polyhedral outer shape. In the determined first region, the grid structure is constructed having a first number of reinforcing elements, and in the determined second region, the structure is constructed having a second number of reinforcing elements, the second number of reinforcing elements being smaller than the first number of reinforcing elements.

The method according to the disclosure herein for designing a structural component can in particular be carried out by a computing device, e.g. in the form of a PC, which comprises a processor unit and a memory unit which can be read out by the processor unit and is suitable for storing data.

The anticipated loading pattern within the structural component can be determined for example by a finite element method on the basis of mechanical constraints, in particular in the form of a direction, point of application and size of forces on the structural component. Therefore, one possible loading scenario of the cross section of the structural component is simulated and the forces and/or stresses which arise as a result of loading within the cross section are calculated for closed volume elements of the cross section.

The regions subject to a high load and the regions subject to a low load can be identified for example on the basis of a comparison process that can be carried out automatically by the computing unit. For example, a threshold for a stress determined for a particular volume element or for a force can be specified, above which threshold the particular volume element is considered to be subject to a high load. The identification then comprises comparing the actual determined force or stress for each volume element with the threshold. If the actual determined force is above the threshold, the relevant volume element is identified as being subject to a high load. If the actual determined force is less than or equal to the threshold, the element is identified as being subject to a low load.

Furthermore, the grid structure is formed or constructed on the basis of the identified regions. The rods which form the grid structure are assembled such that they form regularly repeating basic units. In this case, the basic units provided in a region that has been identified as being subject to a high load are reinforced by additional reinforcing elements, for example in the same way in each case. The basic units provided in a region that has been identified as being subject to a low load can also be reinforced by a smaller number of reinforcing elements. This can also be achieved in an automated manner by the computing unit, for example by position data that describe the rod elements and the reinforcing elements being produced. Owing to the cross section being separated into separate regions and owing to a grid structure being formed having regularly repeating basic units which are all reinforced in the same way, the amount of data can be kept low. This significantly increases the computing speed of the computing unit and reduces the requirements on the processing power of the computing device, in particular on the processor unit.

Constructing the grid structure comprises in particular creating a computer-readable data set comprising information on the geometric properties of the grid structure, such as the sequence, length, thickness, position, etc. of the rod elements and the reinforcing elements.

Constructing the grid structure can in particular comprise selecting at least one first type of basic units and one second type of basic units from a selection of two to five types of basic units having different numbers of reinforcing elements. Therefore, in particular, a rod sequence can be selected which forms a certain basic unit within the grid structure. In this case, the different types are reinforced by different numbers of reinforcing elements.

3D printing methods within the context of the present application include all generative or additive manufacturing methods in which objects having a predefined shape are produced, on the basis of geometric models, from amorphous materials such as liquids and powders or from neutrally shaped semi-finished products such as strip-like or wire-like material by chemical and/or physical processes in a special generative manufacturing system. In the context of the present application, 3D printing methods use additive processes in which the starting material is built up sequentially in layers to form predetermined shapes.

Where “one-piece”, “single-piece”, “integral” components or components “in one piece” are mentioned, these should generally be taken as being present as a single part forming a material unit, and in particular as having been produced as such, it being impossible to detach one component from the other without destroying the material bond.

In this document, where directional details and axes are concerned, in particular directional details and axes relating to the course of physical structures, a course of an axis, direction or structure “along” another axis, direction or structure should be taken to mean that these, in particular the tangents produced at a given point on the structures, extend in each case at an angle of less than or equal to 45° to one another, for example less than 30°, and for example in parallel with one another.

In this document, where directional details and axes are concerned, in particular directional details and axes relating to the course of physical structures, a course of an axis, direction or structure “transversely to” another axis, direction or structure should be taken to mean that these, in particular the tangents produced at a given point on the structures, extend in each case at an angle of greater than or equal to 45° to one another, for example greater than or equal to 60°, and for example perpendicularly to one another.

### BRIEF DESCRIPTION OF THE DRAWINGS

The disclosure herein will be described hereinafter with reference to the figures of the example drawings, in which:

FIG. 1 is a schematic sectional view of a structural component according to an embodiment of the present disclosure;

FIG. 2 is a perspective view of a basic unit of a structural component according to an embodiment of the present disclosure, which basic unit is repeated within a grid structure;

FIG. 3 is a perspective view of a basic unit of a structural component according to an embodiment of the present disclosure, which basic unit is repeated within a grid structure;

FIG. 4 is a perspective view of a grid structure of a structural component according to an embodiment of the present disclosure;

FIG. 5 is a perspective, discontinuous sectional view of a structural component according to another embodiment of the present disclosure;

FIG. 6 is a symbolic flow chart of a method for producing a structural component according to an embodiment of the present disclosure; and

FIG. 7 is a symbolic flow chart of a method for designing a structural component according to an embodiment of the present disclosure.

In the drawings, the same reference signs denote identical or functionally identical components, unless specified otherwise.

### DETAILED DESCRIPTION

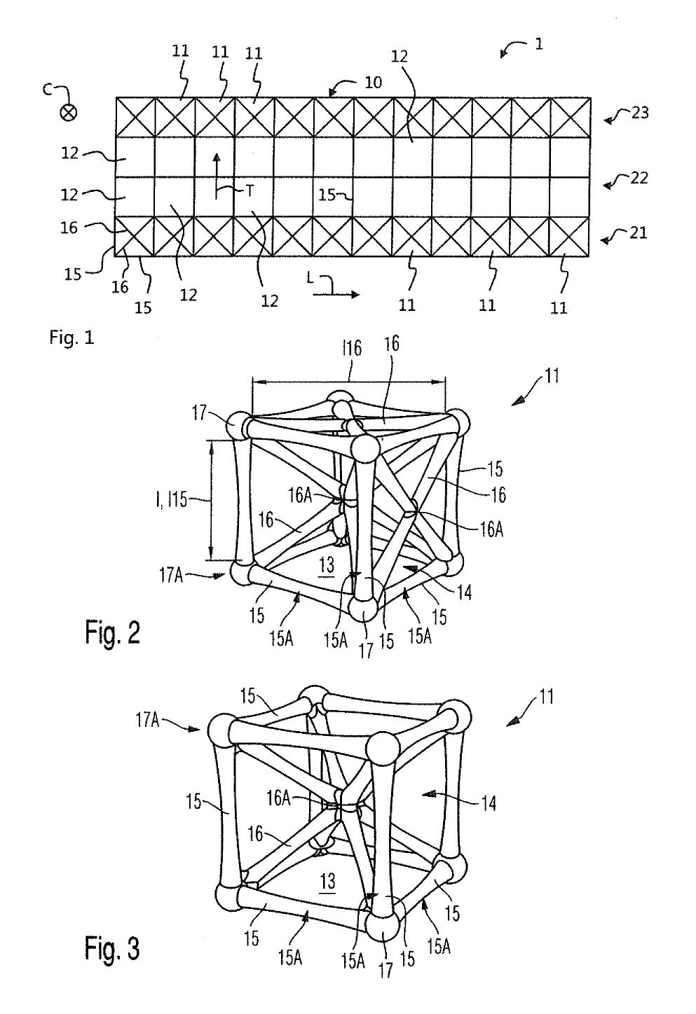

FIG. 1 schematically shows an exemplary design of a structural component 1. The structural component 1 has a grid structure 10 which is constructed in a thickness direction T. As shown symbolically in FIG. 1, the grid structure 10 is constructed from a plurality of rod elements 15. The rod elements 15 form repeating basic units 11, 12 within the grid structure 10. In FIG. 1, this is indicated symbolically by rectangular boxes. The basic units each have the same polyhedral outer shape. As shown by way of example in FIG. 1, a plurality of basic units 11, 12 are in particular formed one after the other in the thickness direction T. FIG. 1 also shows that a plurality of basic units 11, 12 can also be formed in particular one after the other in a component longitudinal direction L which extends transversely to the thickness direction T. Optionally, a plurality of basic units 11, 12 can also be formed in a component transverse direction C which extends transversely to the thickness direction T and the component longitudinal direction L. In general, an open-cell grid structure 10 that extends in space is thus produced which can be advantageously produced in particular by a 3D printing method, for example by an SLS method or an SLM method. The grid structure 10 can be formed in particular in one piece; for example, the grid structure 10 can be produced by a single, continuous 3D printing process.

As is also shown symbolically in FIG. 1, a first number of reinforcing elements 16 are provided in a first region 21 of the grid structure 10, which region is formed in the thickness direction T, and a second number of reinforcing elements 16 are provided in a second region 22 which adjoins the first region 21 in the thickness direction T, the second number of reinforcing elements 16 being smaller than the first number of reinforcing elements 16. FIG. 1 symbolically shows, by way of example, four reinforcing elements 16 for each basic cell 11 in the first region 21, whereas the basic cells 12 in the second region 22 do not have any additional reinforcement. The first and second regions 21, 22 also each extend along one another in the component longitudinal direction L and optionally also in the component transverse direction C that extends transversely to the component longitudinal direction L. As shown by way of example in FIG. 1, the rod elements 15 are assembled to form the grid structure 10 such that the elements form basic units 11 within the first region 21 which are repeated in the component longitudinal direction L. Furthermore, the rod elements 15 are assembled to form the grid structure 10 such that the elements form basic units 12 within the second region 22 which are repeated in the component longitudinal direction L and in the thickness direction T. The grid structure 10 therefore comprises a plurality of separate regions 21, 22 comprising basic units 11, 12, the basic units 11, 12 each being reinforced by the same number of reinforcing elements 16, and the arrangement of the reinforcing elements 16 for example also being regularly repeated within the relevant region 21, 22.

As can be seen in FIG. 1, a grid structure 10 that is regular in regions is produced on a mesoscopic plane. This is particularly favourable in terms of it being possible to produce the structure by a 3D printing method, since the amount of data required for controlling the production method is thus kept low. Therefore, the described grid structure 10 can be produced in a particularly rapid and efficient manner. Furthermore, providing reinforcement which is different in regions results in savings being made in terms of weight, since the number of reinforcing elements 16 in regions that are subject to a low mechanical load, for example in the second region 22, can be kept low.

Exemplary constructive designs of the rod elements 15 and the arrangement thereof in polyhedrons in the grid structure 10 and possible constructive designs of the reinforcing elements 16 will be discussed in detail in the following.

FIG. 1 shows by way of example a structural component which comprises the first region 21, the second region 22 and additionally a third region 23. In this case, the third region 23 is constructed such that it is identical to the first region 21, in particular it is reinforced in the same way by reinforcing elements 16. The third region 23 is arranged such that it is at a distance from the first region 21 in the thickness direction T. The second region 22 extends between the first and third regions 21, 23. Therefore, the structural component 1 shown by way of example in FIG. 1 has a sandwich structure comprising a core in the form of the second region and outer regions which are in the form of the first and third regions 21, 23 and are reinforced with respect to the core. Generally, two to five different regions 21, 22, 23 having different numbers of reinforcing elements 16 can be provided.

The structural component 1 can be designed in particular as a component which extends in a planar manner and is in particular flat or dished, as shown in FIG. 5 for example. Furthermore, the structural component 1 can also be designed as an elongate, beam-shaped or girder-shaped component (not shown), e.g. as a T-beam, H-beam, U-beam or as a beam having a polygonal cross section. The rod elements 15 are generally arranged such that they form basic units 11, 12 which are repeated within the grid structure and each have the same polyhedral outer shape. In this way, the arrangement of the rod elements 15 defines the cross-sectional shape and the extension in space of the structural component 1.

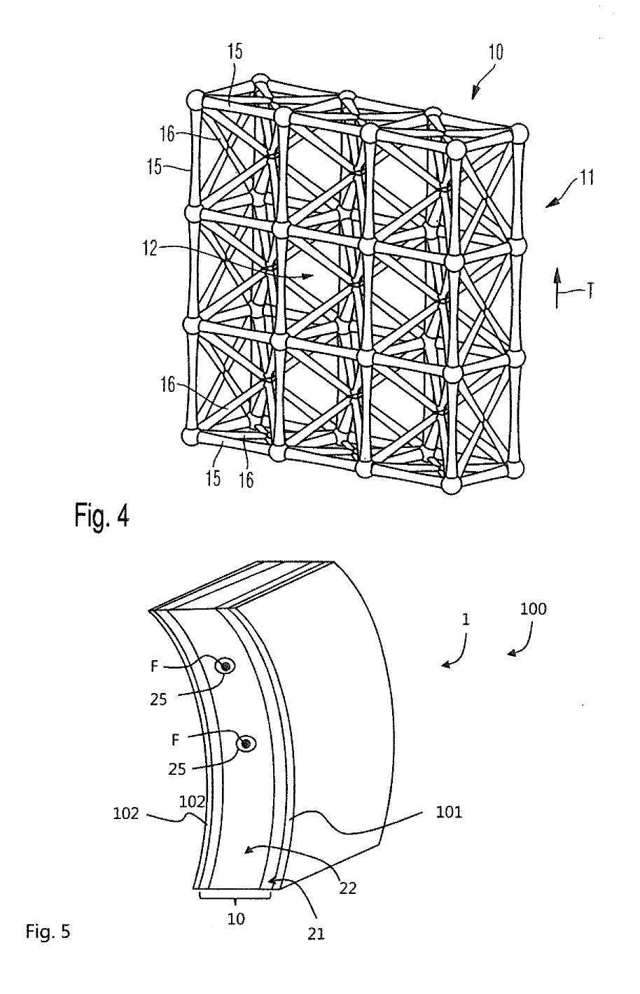

FIG. 4 shows, by way of example, part of a grid structure 10. The grid structure 10 is assembled from a plurality of rod elements 15 such that the elements form basic units 11, 12 which are regularly repeated within the grid structure 10. FIGS. 2 and 3 each show, by way of example, basic units 11, 12 of which the outer shape is a polyhedron in the form of a cuboid. The rod elements 15 form the edges 15A of the cuboid. In the cuboid basic units 11, 12 shown by way of example in FIGS. 2 and 3, four rod elements 15 define a face 14 of the cuboid in each case. The faces 14 also define an interior space 13 of the cuboid. At least three rod elements 15, or exactly three rod elements 15 in the case of the cuboid shown by way of example in FIGS. 2 and 3, form in each case a corner 17 of the basic unit 11, 12. The basic units 11, 12 can of course also have a different outer shape, for example that of a hexahedron, an octahedron, a truncated octahedron, a tetrahedron, a double tetrahedron, a polygonal prism, a dodecahedron, an icosahedron or an icosidodecahedron.

As is also shown in FIGS. 2 and 3, an accumulation 17A of material can be provided at each corner 17, which accumulation of material has for example a spherical outer shape, as shown by way of example in FIGS. 2 and 3. This produces a mechanically stable connection between the rod elements 15. This also prevents stress concentrations in the region of the connection points of a plurality of rod elements 15 and thus produces a grid structure 10 that is extremely stable and durable.

The rod elements 15 are designed as elongate components having a length 115. The length 115 can in particular be in a range of between 2 mm and 15 mm, for example in a range of between 5 mm and 10 mm. In FIGS. 2 and 3, the rod elements 15 are each shown having a circular cross section by way of example. This is advantageous in that a cross section of this shape can be produced in a simple manner, for example by a 3D printing method. Furthermore, rod elements 15 having a circular cross section have high torsional and flexural strength.

As can be seen in FIG. 2 through 4, reinforcing elements 16 are provided within the grid structure 10 in addition to the rod elements 15. As shown in FIG. 4, different numbers of reinforcing elements 16, in particular for each basic unit 11, 12, are provided in different regions of the grid structure 10.

FIG. 2 shows by way of example a first type of basic unit 11 which comprises a total of eight reinforcing elements 16. FIG. 3 shows by way of example a second type of basic unit 12 which comprises a total of four reinforcing elements 16. The reinforcing elements 16 each extend in the interior space 13 of the relevant basic unit 11, 12 or in a face 14 of the relevant basic unit 11, 12. In general, one reinforcing element 16 connects at least two rod elements 15.

As shown in FIGS. 2 and 3 by way of example, each reinforcing element 16 can in particular extend between vertices 17 of the polyhedron. In the basic unit 11 shown in FIG. 2, in each of two faces 14, two reinforcing elements 16 extend between two diagonally opposite corners 17. The faces 16 in which the reinforcing elements 16 extend extend from a common edge 15A according to the example view in FIG. 2. Furthermore, in the basic unit 11 shown in FIG. 2, four reinforcing elements 16 which extend in the interior space 13 of the polyhedron are provided, which elements each extend between diagonally opposite corners 17. The basic unit 12 shown by way of example in FIG. 3 differs from the basic unit 11 shown in FIG. 2 merely in that the basic unit 12 shown by way of example in FIG. 3 does not have any reinforcing elements 16 which extend in the faces 14.

The structural component 1, for example the structural component 1 shown schematically in FIG. 1, can therefore be produced having, for example, a grid structure 10 in which the rod elements 15 are arranged such that they form the basic units 11 shown in FIG. 2 in the first region 21 and such that they form the basic units 12 shown in FIG. 3 in the second region 22. In the optional third region 23, the grid structure 10 can also be assembled for example from the rod elements 15 such that the basic units 11 shown in FIG. 2 are formed. Therefore, a grid structure 10 is produced that is very simple, in particular regular in regions, and mechanically robust. The structure can be constructed, for example, in a particularly efficient manner in the thickness direction T by a 3D printing method.

As shown in FIG. 2 through 4, the reinforcing elements 16 can be designed in particular as rods, i.e. as elongate components, having a length 116. The length 116 can be in particular at least 1.41 times the length 115 of the rod elements 15. In FIGS. 2 and 3, the reinforcing elements 16 are each shown having a circular cross section by way of example. This is advantageous in that a cross section of this shape can be produced in a simple manner, for example by a 3D printing method. Furthermore, reinforcing elements 16 having a circular cross section have high torsional and flexural strength.

As shown by way of example in FIGS. 2 and 3, all reinforcing elements 16 which extend in the interior space 13 intersect one another in a node point 16A and are interconnected therein, in particular fastened to one another. In the basic cell 11 shown in FIG. 2, the two reinforcing elements 12 which extend in the relevant face 14 in each case also intersect one another in a node point 16A and are interconnected therein, in particular fastened to one another. This gives the basic cells 11, 12 very high torsional rigidity.

The “torsional rigidity” of a basic unit 11, 12 can be understood in particular to mean resistance, measured as a force or moment, of a particular basic cell 11, 12 to elastic deformation when a force or a moment is applied to the basic cell 11, 12, in the form of a unit that is detached from the grid structure, such as a unit shown in FIGS. 2 and 3, for example when forces are applied which are directed in opposite directions, each act along opposite faces and are required in order to achieve a certain degree of deformation. The torsional rigidity can in particular be understood to mean the average of values determined for all pairs of opposite faces. In order to compare the torsional rigidity of different basic cells 11, 12, basic cells that are assembled from rod elements 15 and reinforcing elements 16 of the same materials should be taken into account.

In FIG. 2, an edge length I of the basic unit 11 is indicated. “Edge length I” can be understood in particular to mean the length 115 of a particular rod element 15. The edge length 1 is in particular in a range of between 2 mm and 15 mm.

The rod elements 15 and the reinforcing elements 16 can be made in particular of a plastics material or of a metal material.

FIG. 5 shows by way of example a possible use for the structural component 1 as a fuselage component 100 of an aircraft (not shown). The structural component extends in this case in a planar manner and is dished, in particular shaped in the manner of a circle segment. Furthermore, an optional first cover layer 101 and an optional second cover layer 102 are additionally provided, the grid structure 10 being arranged, in relation to the thickness direction T, between the first and second cover layers 101, 102. The first cover layer 101 can form for example an outer skin of the aircraft. The second cover layer 102 can be formed for example by an air-tight membrane.

As is also shown in FIG. 5, gaps 25 for receiving functional components F can be formed within the grid structure 10. The gaps 25 can be formed, for example, as basic cells 11, 12 that do not have connecting elements 16 extending therein. Alternatively or additionally, rod elements 15 and/or connecting elements 16 can be omitted within the grid structure 10 over a separate region that extends in the thickness direction T and additionally in the component longitudinal direction L and/or the component transverse direction C. The functional components F can be cables or lines, for example, as shown schematically in FIG. 5.

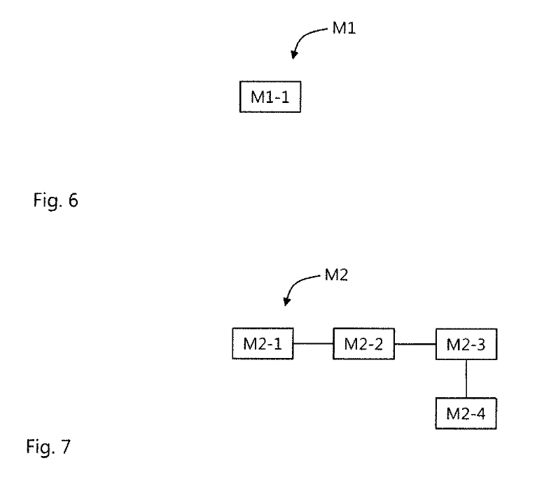

FIG. 6 schematically shows the sequence of a method M1 for producing a structural component 1. The method M1 is explained in more detail in the following by way of example and with reference to the above-described embodiments of the structural component 1.

In the method, the grid structure 10 of the structural component is constructed M1-1 in the thickness direction T from a plurality of rod elements 15 by a 3D printing method. This comprises in particular forming the individual rod elements 15 and the reinforcing elements 16 in layers such that they each extend from a raw material. The grid structure 10 can be produced in particular in one piece by a single, continuous 3D printing process. For example, in the thickness direction T, the rod elements 15 that form the first region 21 and the associated reinforcing rods 16 of the grid structure 10 can be formed continuously one after the other and the rod elements 15 that form the second region 22 and the associated reinforcing rods 16 of the grid structure 10 can be formed continuously one after the other.

The 3D printing method can involve in particular a selective laser sintering (SLS) method or a selective laser melting (SLM) method. In the SLS method and in the SLM method, a component is built up in layers from a modelling material, for example a plastics material (SLS method) or a metal (SLM method), by the modelling material being applied in powder form to an underlayer and being liquefied in a targeted manner by local laser irradiation, whereby, after cooling, a solid, continuous component is produced. These methods are advantageous in terms of the grid structure to be constructed in particular in that, during construction of the rod elements 15 or reinforcing elements 16, the powdered material is used as a supporting material for supporting the rod elements 15 or reinforcing elements 16. The grid structure 10 can thus be produced with a high level of precision.

FIG. 7 schematically shows the sequence of a method M2 for designing a structural component 1. This method M2 is also explained in more detail in the following by way of example and with reference to the above-described embodiments of the structural component 1.

The method M2 for designing a structural component can in particular be carried out by a computing device (not shown), e.g. in the form of a PC, which comprises a processor unit and a memory unit which can be read out by the processor unit and is suitable for storing data.

In a first method step M2-1, an anticipated loading pattern within the structural component 1 is first determined. The anticipated loading pattern within the structural component can be determined for example by a finite element method on the basis of mechanical constraints, in particular in the form of a direction, point of application and size of forces on the structural component 1. One possible loading scenario of the cross section of the structural component 1 is simulated and the forces and/or stresses which arise as a result of loading within the cross section are calculated for closed volume elements of the cross section.

In a further method step, at least one first region 21 of the structural component 1 that is subject to a high mechanical load and one second region 22 of the structural component that is subject to a low mechanical load are identified M2-2. This can comprise in particular comparing the actual determined force or stress for each volume element with a predetermined threshold. If the actual determined force is above the threshold, the relevant volume element is identified as being subject to a high load. If the actual determined force is less than or equal to the threshold, the element is identified as being subject to a low load.

In a further step, the grid structure 10 that forms the structural component is constructed M2-3. This comprises in particular creating a data set describing the position and the extension of the rod elements 15 and of the reinforcing elements 15.

The step of constructing M2-2 the grid structure can also comprise selecting M2-4 at least one first type of basic units 11 and one second type of basic units 11 from a selection of two to five types of basic units 11, 12 having different numbers of reinforcing elements 16. For example, in addition to the types of basic units 11, 12 shown in FIGS. 2 and 3, other basic units can be provided which are designed having more or fewer reinforcing elements 16 than the types, and which can be formed so as to be repeated within the grid structure 10 by the rod elements 15 and the reinforcing elements 16. The selection M2-4 can be made for example such that the torsional rigidity of the relevant basic unit can be compared with the load determined for a volume unit of the cross section. In particular, it is then possible to select the basic unit of which the torsional rigidity is least different from the force determined for the relevant volume unit of the cross section.

Although the present disclosure has been explained by way of example above on the basis of embodiments, it is not limited to these embodiments, but rather may be modified in a number of different ways. In particular, combinations of the above embodiments are also conceivable.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A structural component, having a grid structure which is constructed from a plurality of rod elements in a thickness direction, wherein the rod elements form basic units which are repeated within the grid structure and each have a same polyhedral outer shape; and
wherein a first number of reinforcing elements are provided in a first region of the grid structure, wherein the first region is formed in the thickness direction, and a second number of reinforcing elements are provided in a second region which adjoins the first region in the thickness direction, wherein the second number of reinforcing elements is smaller than the first number of reinforcing elements.

2. The structural component of claim 1, wherein the reinforcing elements extend in an interior space of a relevant basic unit.

3. The structural component of claim 1, wherein the reinforcing elements extend in faces of a relevant basic unit.

4. The structural component of claim 1, wherein the reinforcing elements are formed by rods.

5. The structural component of claim 4, wherein at least two reinforcing elements in each case intersect one another in a node point in which the reinforcing elements are interconnected.

6. The structural component of claim 1, wherein the reinforcing elements extend between the rod elements.

7. The structural component of claim 6, wherein the reinforcing elements extend between vertices of a polyhedron.

8. The structural component of claim 1, wherein the reinforcing elements have a length which is at least 1.41 times a length of the rod elements.

9. The structural component of claim 1, wherein two to five different regions having different numbers of reinforcing elements are within the grid structure.

10. The structural component of claim 1, wherein the outer shape of each of the basic units is a cuboid, a hexahedron, an octahedron, a truncated octahedron, a tetrahedron, a double tetrahedron, a polygonal prism, a dodecahedron, an icosahedron or an icosidodecahedron.

11. The structural component of claim 1, wherein an edge length of each basic unit is in a range of between 2 mm and 15 mm.

12. The structural component of claim 1, wherein the rod elements and the reinforcing elements are made of a plastics material.

13. The structural component of claim 1, wherein the rod elements and the reinforcing elements are made of a metal material.

14. The structural component of claim 1, wherein gaps for receiving functional components are formed within the grid structure.

15. A method for producing a structural component, comprising:
constructing a grid structure, by a 3D printing method, in a thickness direction from a plurality of rod elements such that the rod elements form basic units which are repeated within the grid structure and each have a same polyhedral outer shape, and such that in a thickness direction a first region of the grid structure is formed having a first number of reinforcing elements and a second region which adjoins the first region in the thickness direction is formed having a second number of reinforcing elements, wherein the second number of reinforcing elements is smaller than the first number of reinforcing elements.

16. The method of claim 15, wherein the 3D printing method comprises a selective laser sintering method.

17. The method of claim 15, wherein the 3D printing method comprises a selective laser melting method.

18. A method for designing a structural component, comprising:
determining an anticipated loading pattern within the structural component;
identifying at least one first region of the structural component that is subject to a high mechanical load and one second region of the structural component that is subject to a low mechanical load;
constructing a grid structure that forms the structural component and has a plurality of rod elements, wherein the rod elements form basic units which are repeated within the grid structure and each have a same polyhedral outer shape, and wherein in the determined first region the grid structure is constructed having a first number of reinforcing elements and in the second region the structure is constructed having a second number of reinforcing elements, wherein the second number of reinforcing elements is smaller than the first number of reinforcing elements.

19. The method of claim 18, wherein constructing the grid structure comprises selecting at least one first type of basic units and one second type of basic units from a selection of two to five types of basic units having different numbers of reinforcing elements.
